(19) United States
(12) Patent Application Publication
(10) Pub. No.: US 2016/0257295 A1
(43) Pub. Date: Sep. 8, 2016

(54) SYSTEMS AND METHODS FOR ADJUSTING KINETIC ENERGY IN A HYBRID VEHICLE BEFORE AND DURING A CHANGE IN ROAD GRADE

(71) Applicant: FORD GLOBAL TECHNOLOGIES, LLC, Dearborn, MI (US)

(72) Inventors: Kenneth James MILLER, Canton, MI (US); Thomas G. LEONE, Ypsilanti, MI (US)

(21) Appl. No.: 14/640,366

(22) Filed: Mar. 6, 2015

(51) Int. Cl. B60W 20/13; B60W 20/14

(52) U.S. Cl. CPC B60W 20/13; B60W 20/14; B60W 2550/142

(57) ABSTRACT

A method of controlling a hybrid vehicle includes automatically varying a current vehicle speed away from a target vehicle speed. The automatic variation of vehicle speed is response to an adaptive cruise control system being active with a target vehicle speed being selected, and in response to an anticipated change in power demand for maintaining the target vehicle speed. The anticipated change in power demand is based on a detected upcoming change in road grade, and the automatica variation in current vehicle speed away from the target vehicle speed is performed prior to arriving at the change in road grade.

### TECHNICAL FIELD

This disclosure relates to systems and methods for controlling a vehicle equipped with an adaptive cruise control system and equipped for regenerative braking.

### BACKGROUND

Adaptive Cruise Control (ACC) systems use an on-board sensor (usually RADAR or LIDAR) to detect the distance between the host vehicle and a vehicle ahead of the host (the lead vehicle), and the relative speed difference between the vehicles. The system then automatically adjusts the speed of the host vehicle to keep it at a pre-set distance behind the lead vehicle, even in most fog and rain conditions. Typically, the host vehicle driver can set a desired/minimum following distance and/or a time gap to be maintained between vehicles. The ACC generates automatic interventions in the powertrain and/or braking systems of the host vehicle to slow the vehicle as necessary to maintain the selected minimum following distance.

### SUMMARY

A system and method of controlling a hybrid vehicle includes automatically altering a current vehicle speed away from a target vehicle speed. The automatic alteration of vehicle speed is in response to an automated speed control system being active with a target vehicle speed being selected, and in response to an anticipated change in power demand for maintaining the target vehicle speed. The automated speed control system may be an adaptive cruise control system. The anticipated change in power demand is based on a detected upcoming change in road grade, and the automatic alteration in current vehicle speed away from the target vehicle speed is performed prior to arriving at the change in road grade.

In one embodiment, the detected upcoming change in road grade is an upcoming increase in road grade, and automatically altering current vehicle speed away from the target vehicle speed includes increasing the vehicle speed to a first vehicle speed above the target vehicle speed. The first vehicle speed may be based on the lesser of a posted speed limit, and a required speed to maintain electric mode operation at or above the target vehicle speed through the upcoming increase in road grade.

In another embodiment, the detected upcoming change in road grade is an upcoming decrease in road grade, and automatically altering current vehicle speed away from the target vehicle speed includes decreasing the vehicle speed to a second vehicle speed below the target vehicle speed. The difference between the target vehicle speed and the second vehicle speed may be based on a required speed to maintain vehicle speed at or below the target vehicle speed through the upcoming decrease in road grade without application of vehicle friction brakes.

A hybrid electric vehicle according to the present disclosure includes traction wheels, a regenerative braking system configured to provide regenerative braking torque to the traction wheels, wheel brakes configured to provide friction braking torque to the traction wheels, and an adaptive cruise control (ACC) system. The ACC system is configured to control vehicle power and braking requests for the regenerative braking system and wheel brakes to maintain a target speed. The ACC system is further configured to, in response to an anticipated change in power demand for maintaining the target speed based on a detected upcoming change in road grade, automatically alter a current vehicle speed away from the target speed prior to arriving at the change in road grade.

A method of controlling a hybrid electric vehicle according to the present disclosure includes automatically increasing current vehicle speed above a target vehicle speed prior to arriving at an increase in road grade. The automatic increase in current vehicle speed is in response to an ACC system being active with a first target vehicle speed being selected, and further in response to a detected upcoming increase in road grade. The method further includes automatically decreasing current vehicle speed below the target vehicle speed prior to arriving at a decrease in road grade. The automatic decrease in current vehicle speed is in response to the ACC system being active, a second target vehicle speed being selected, and a detected upcoming decrease in road grade.

Embodiments according to the present disclosure provide a number of advantages. For example, the present disclosure provides an ACC system with increased fuel economy through changes in road grade. During descents, an increased portion of kinetic energy may be recaptured by regenerative braking, and during ascents the vehicle may be maintained in electric-only mode without starting the vehicle engine.

The above advantage and other advantages and features of the present disclosure will be apparent from the following detailed description of the preferred embodiments when taken in connection with the accompanying drawings.

### BRIEF DESCRIPTION OF THE DRAWINGS

FIG. 1 is a schematic representation of a vehicle according to the present disclosure;

FIG. 2A illustrates a prior art driving event during a decrease in road grade;

FIG. 2B illustrates a prior art driving event during an increase in road grade;

FIG. 3 illustrates a method of controlling a vehicle according to the present disclosure in flowchart form;

FIG. 4A illustrates an example speed variation event prior to and during a decrease in road grade according to the present disclosure; and

FIG. 4B illustrates an example speed variation event prior to and during an increase in road grade according to the present disclosure.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

Adaptive Cruise Control (ACC) refers to a control method for automatically controlling a host vehicle, including maintaining both a desired speed and distance from forward vehicles in the lane of travel. A host vehicle equipped with ACC is configured to maintain at least a predefined distance from a target vehicle positioned forward of the host vehicle. An ACC system generally includes at least one sensor, such as RADAR, LIDAR, ultrasonics, cameras, or other sensors or combination thereof. The ACC system is configured to directly or indirectly control throttle and brake systems to control host vehicle acceleration and deceleration according to an ACC algorithm.

Some vehicles equipped with ACC systems may also include powertrains equipped for regenerative braking. Regenerative braking refers to the recapture and storage of vehicle kinetic energy for subsequent use by the vehicle. Regenerative braking systems generally include an electric machine or motor/generator configured to apply braking torque to vehicle traction wheels and generate electric power. Other systems may include accumulators, flywheels, or other mechanisms for storing energy for subsequent use.

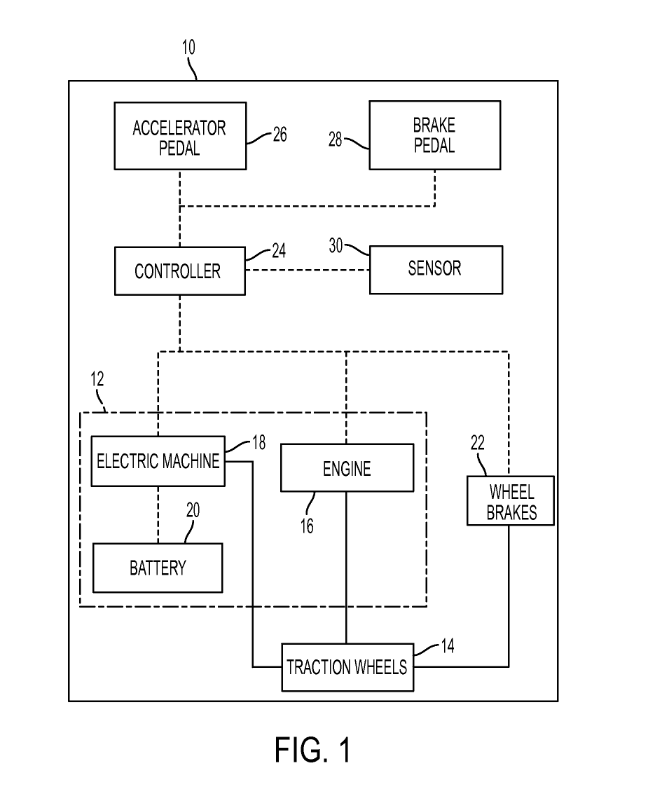

Referring now to FIG. 1, a host vehicle 10 according to the present disclosure is illustrated in schematic form. The host vehicle 10 includes a hybrid powertrain 12 configured to deliver power to traction wheels 14. The hybrid powertrain 12 includes an internal combustion engine 16 and at least one electric machine 18, each configured to deliver power to the vehicle traction wheels. The electric machine 18 is electrically coupled to a battery 20. In various embodiments, the powertrain 12 may be arranged as a series, parallel, or series-parallel powertrain.

The electric machine 18 is also configured to provide regenerative braking torque to the traction wheels 14, in which rotational energy from the traction wheels 14 is converted to electrical energy. Electrical energy generated by the electric machine 18 may be stored in the battery 20 for subsequent use by the host vehicle 10.

The host vehicle 10 additionally includes wheel brakes 22 configured to provide friction braking torque to the traction wheels 14.

The electric machine 18, engine 16, and wheel brakes 22 are all in communication with or under the control of at least one controller 24. Although illustrated as a single controller, the controller 24 may be part of a larger control system and/or may be controlled by various other controllers throughout the host vehicle 10. In one embodiment, the controller 24 is a powertrain control unit (PCU) under the control of a vehicle system controller (VSC). The controller 24 and one or more other controllers can collectively be referred to as a “controller.” The controller 24 may include a microprocessor or central processing unit (CPU) in communication with various types of computer readable storage devices or media. Computer readable storage devices or media may include volatile and nonvolatile storage in read-only memory (ROM), random-access memory (RAM), and keep-alive memory (KAM), for example. KAM is a persistent or non-volatile memory that may be used to store various operating variables while the CPU is powered down. Computer-readable storage devices or media may be implemented using any of a number of known memory devices such as PROMs (programmable read-only memory), EPROMs (electrically PROM), EEPROMs (electrically erasable PROM), flash memory, or any other electric, magnetic, optical, or combination memory devices capable of storing data, some of which represent executable instructions, used by the controller in controlling the engine or vehicle.

The host vehicle 10 additionally includes an accelerator pedal 26 and a brake pedal 28. In response to a driver actuation of the accelerator pedal 26, the controller 24 is configured to coordinate the electric machine 18 and engine 16 to provide power to the traction wheels 14. In response to a driver actuation of the brake pedal 28, the controller 24 is configured to control the electric machine 18 and/or wheel brakes 22 to provide braking torque to the traction wheels 14.

Regenerative braking systems generally have a powertrain braking torque limit, referring to a maximum amount of braking torque the system is capable of applying to traction wheels under current operating conditions. In typical regenerative braking systems including an electric machine acting as a generator, the regenerative braking torque limit is generally based on motor torque capabilities, current gear in embodiments having a step-ratio transmission, battery energy delivery limits (e.g. a battery state of charge), and other powertrain limits.

In response to a brake request that does not exceed the regenerative braking torque limit, the controller 24 is configured to control the electric machine 18 to provide regenerative braking torque to satisfy the braking request. In response to a braking request that does exceed the regenerative braking torque limit, the controller 24 is configured to control the electric machine 18 and wheel brakes 22 to satisfy the braking request.

The host vehicle 10 further includes at least one sensor 30. The sensor 30 may include RADAR, LIDAR, ultrasonic sensors, optical camera(s), or other sensors or a combination thereof. The sensor 30 is configured to detect objects forward of the host vehicle 10. In particular, the sensor 30 is oriented to detect a vehicle forward and in a same driving lane as the host vehicle 10.

The controller 24 is configured to control the host vehicle acceleration and braking according to an ACC algorithm in response to detection of a forward vehicle via the sensor 30. This may include coordinating the engine 16 and/or electric machine 18 to satisfy an ACC acceleration request. This may additionally include coordinating the engine 16, electric machine 18, and/or wheel brakes 22 to satisfy an ACC deceleration request. Generally speaking, the ACC algorithm is configured to maintain a target cruising speed and automatically adjust speed of the host vehicle 10 to maintain a pre-set distance behind a detected forward vehicle based on a detected distance to and speed of the forward vehicle. In some variants, the host vehicle driver may set a desired/minimum following distance and/or a time gap to be maintained between vehicles.

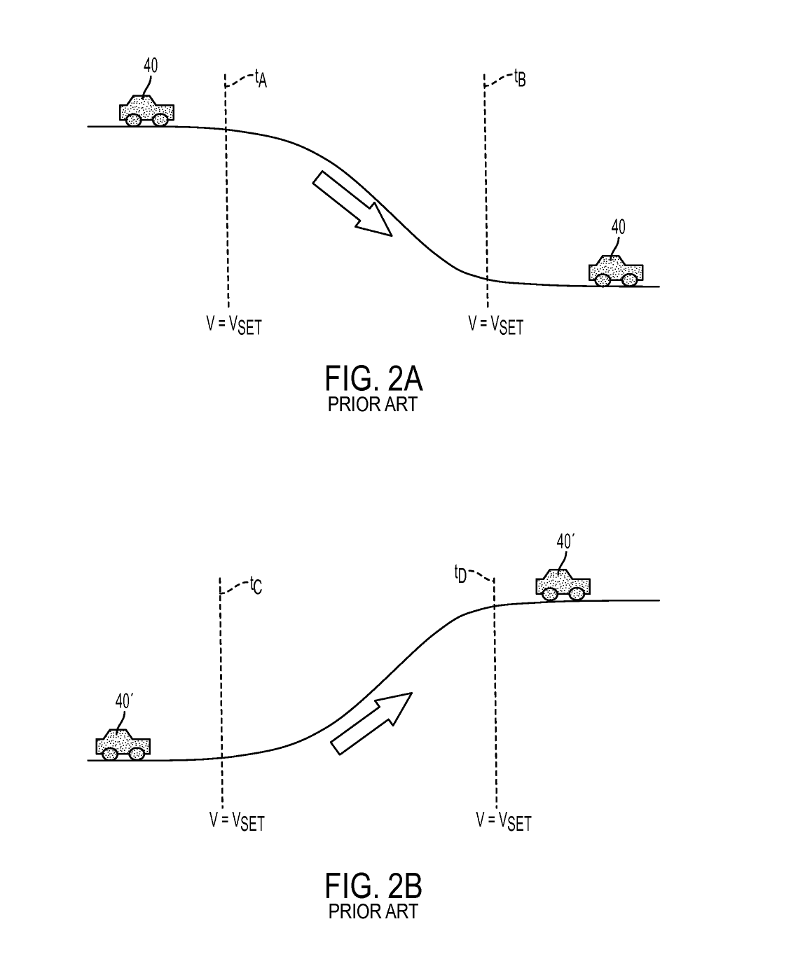

Known ACC algorithms are configured to maintain vehicle speed at the target cruising speed regardless of road grade. Referring to FIG. 2A, an example of a prior art ACC system controlling a vehicle during a decrease in road grade is illustrated. The vehicle 40 is equipped with a prior art ACC algorithm and approaches a decrease in road grade with the ACC system active. The vehicle 40 is traveling at a current velocity v that is approximately equal to a set speed vₛₑₜ. At time t_{A}, the vehicle 40 reaches a decrease in road grade. At time t_{A}, the vehicle is travelling at the set speed vₛₑₜ. During the descent, between time t_{A} and time t_{B}, the ACC system in vehicle 40 controls vehicle brakes to maintain the vehicle speed at approximately vₛₑₜ. If the vehicle 40 is equipped for regenerative braking, some of the energy gained while descending may be recaptured. However, if the decrease in road grade is too great, friction braking may be required to maintain the vehicle speed at approximately vₛₑₜ. At time t_{B}, the vehicle 40 arrives at the bottom of the descent with a current vehicle speed approximately equal to vₛₑₜ.

Referring to FIG. 2B, an example of a prior art ACC system controlling a vehicle during an increase in road grade is illustrated. The vehicle 40′ is equipped with a prior art ACC algorithm and approaches an increase in road grade with the ACC system active. The vehicle 40′ is traveling at a current velocity v that is approximately equal to a set speed vₛₑₜ. At time t_{C}, the vehicle 40′ reaches an increase in road grade. At time t_{C}, the vehicle is travelling at the set speed vₛₑₜ. During the ascent, between time t_{C} and time t_{D}, the ACC system in vehicle 40′ controls vehicle brakes to maintain the vehicle speed at approximately vₛₑₜ. This may require a substantial increase in vehicle power. If the vehicle 40′ is a hybrid vehicle capable of operating in an electric only mode and is in electric-only mode at time t_{C}, the engine may be required to start during the ascent to provide the required power. At time t_{D}, the vehicle 40′ arrives at the top of the ascent with a current vehicle speed approximately equal to vₛₑₜ.

As may be seen, known ACC systems may be inefficient during increases or decreases in road grade. During a descent, the magnitude of braking required to maintain the target speed may exceed regenerative braking limits of the vehicle, resulting in wasted energy. During an ascent in electric-only mode, the increase in required power to maintain the vehicle speed may necessitate an engine start, consuming additional fuel.

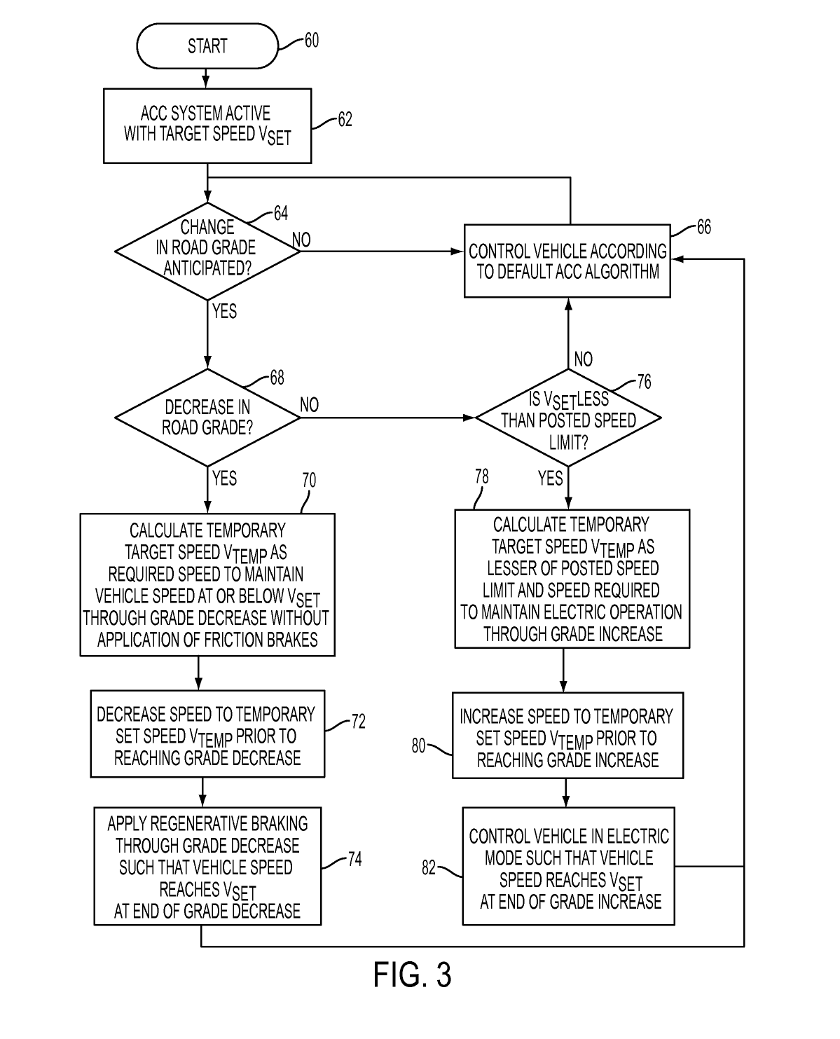

Referring now to FIG. 3, a method of controlling a vehicle according to the present disclosure is shown in flowchart form. The algorithm begins at block 80. The ACC system is active, as illustrated at block 62. A target vehicle speed vₛₑₜ is set. The target vehicle speed vₛₑₜ may be a driver-established set speed. In embodiments configured for driverless operation, the target vehicle speed vₛₑₜ may alternatively be established according to an automated driving algorithm.

A determination is made of whether a change in road grade is anticipated within a defined driving distance, as illustrated at operation 64. In one embodiment, a change in road grade is anticipated based on a comparison of a current vehicle location and heading against topographical mapping information stored in as vehicle navigation system. In another embodiment, a change in road grade is anticipated based on grade information stored from a previous drive cycle along the current vehicle route. In yet another embodiment, a change in road grade is anticipated based on grade information transmitted from a forward vehicle using a vehicle-to-vehicle-communication system, or transmitted from local infrastructure using a vehicle-to-infrastructure-communication system. In one variant, a minimum grade change threshold and/or minimum elevation change threshold is provided, and a change in grade is anticipated only when the change in road grade and/or elevation exceeds the respective threshold.

If no change in road grade is anticipated, the vehicle is controlled according to the default ACC algorithm, as illustrated at block 66.

If a change in road grade is anticipated, a determination is made of whether the change in road grade is a decrease in road grade, as illustrated at operation 68.

If the change in road grade is a decrease, i.e. a downhill portion of a road, then a temporary set speed vₜₑₘₚ is calculated, as illustrated at block 70. The temporary set speed vₜₑₘₚ is determined such that, when travelling at vₜₑₘₚ at the beginning of the decrease in road grade, vehicle speed may be maintained at or below the target speed vₛₑₜ through the region of grade decrease without application of friction brakes, e.g. using only regenerative braking. The temporary set speed vₜₑₘₚ may be calculated using known kinematics equations based on factors including, but not limited to, the target speed vₛₑₜ, vehicle mass, the total elevation change and travel distance of the hill, the maximum regenerative power storage rate, the battery state of charge, the desired battery state of charge, and vehicle coasting coefficients.

Subsequently, the vehicle speed is reduced from vₛₑₜ to vₜₑₘₚ prior to reaching the grade decrease, as illustrated at block 72. In a preferred embodiment, a minimum speed threshold for vₜₑₘₚ is provided to ensure that vehicle speed does not drop to undesirable levels relative to a flow of traffic or relative to individual driver preferences. In various embodiments, the minimum speed threshold may be a calibratable value or inferred from previous driver behavior.

Regenerative braking is then applied through the grade decrease without application of friction brakes, or with minimal application of friction brakes, as illustrated at block 74. The vehicle speed may gradually increase through this interval and preferably reaches vₛₑₜ at the end of the grade decrease. In a preferred embodiment, the ACC system is configured to brake more heavily, e.g. using friction brakes, if necessary based on a detected object forward of the vehicle.

After completion of the grade decrease, i.e. the road is approximately level, control returns to block 66 and the vehicle is controlled according to the default ACC algorithm.

Returning to operation 68, if the change in road grade is not a decrease, i.e. the change is an increase in road grade, then a determination is made of whether the target speed vₛₑₜ is less than the posted speed limit, as illustrated at operation 76. The posted speed limit may be obtained, for example, using stored mapping data, vehicle-to-infrastructure communication, or camera recognition of speed-limit signs.

If the target speed vₛₑₜ is equal to or greater than the posted speed limit, the vehicle is controlled according to the default ACC algorithm, as illustrated at block 66.

If the target speed is less than the posted speed limit, a temporary set speed vₜₑₘₚ is calculated, as illustrated at block 78. The temporary set speed vₜₑₘₚ is determined as the lesser of the posted speed limit and a speed required to maintain electric operation through a grade increase. The speed required to maintain electric operation through a grade increase may be calculated using known kinematics equations based on factors including, but not limited to, those discussed above.

Subsequently, the vehicle speed is increased from vₛₑₜ to vₜₑₘₚ prior to reaching the grade increase, as illustrated at block 80. In a preferred embodiment, the speed increase is performed at a power level achievable in electric-only mode.

The vehicle is then controlled in electric-only mode such that the vehicle speed reaches vₛₑₜ at the end of the grade increase, as illustrated at block 82.

After completion of the grade increase, i.e. the road is approximately level, control returns to block 66 and the vehicle is controlled according to the default ACC algorithm.

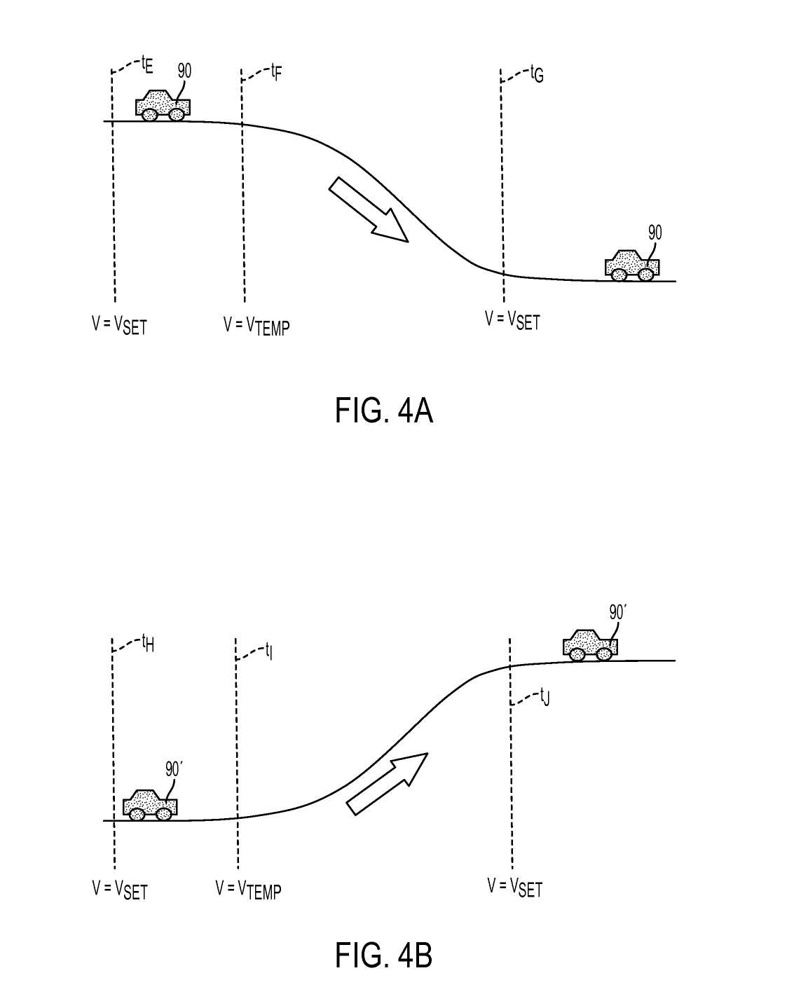

Referring now to FIG. 4A, an example of an ACC system controlling a vehicle according to the present disclosure during a decrease in road grade is illustrated. The vehicle 90 is equipped with an ACC algorithm and approaches a decrease in road grade with the ACC system active at time t_{E}. The vehicle 90 is traveling at a current velocity v that is approximately equal to a set speed vₛₑₜ. At time t_{E}, the upcoming decrease in road grade is detected, and a temporary reduced target speed vₜₑₘₚ is calculated. The temporary reduced target speed vₜₑₘₚ is determined such that the vehicle speed may be maintained at or below vₛₑₜ through the decrease in road grade without application of vehicle friction brakes. The vehicle is subsequently decelerated such that the current vehicle speed is reduced to vₜₑₘₚ as the vehicle 90 reaches the decrease in road grade at time t_{F}. During the descent, between time t_{F} and time t_{G}, the ACC system in vehicle 90 controls vehicle regenerative brakes to maintain the vehicle speed at or below vₛₑₜ. At time t_{G}, the vehicle 90 arrives at the bottom of the descent with a current vehicle speed approximately equal to vₛₑₜ. Because the vehicle speed was reduced prior to the decrease in grade, an increased amount of kinetic energy may be recaptured by regenerative braking during the decrease in grade relative to prior art systems.

Referring to FIG. 4B, an example of an ACC system controlling a vehicle according to the present disclosure during an increase in road grade is illustrated. The vehicle 90′ is equipped with an ACC algorithm and approaches an increase in road grade with the ACC system active at time t_{H}. The vehicle 90′ is traveling at a current velocity v that is approximately equal to a set speed vₛₑₜ. At time t_{H}, the upcoming increase in road grade is detected, and a temporary increased target speed vₜₑₘₚ is calculated. The temporary increased target speed vₜₑₘₚ is determined such that the vehicle may be maintained in electric mode through the increase in road grade. The vehicle is subsequently accelerated such that the current vehicle speed is increased to vₜₑₘₚ as the vehicle 90′ reaches the increase in road grade at time t_{I}. During the ascent, between time t_{I} and time t_{J}, the ACC system in vehicle 90′ controls the vehicle in electric-only mode. During this time interval, the vehicle speed decreases toward vₛₑₜ. At time t_{J}, the vehicle 90′ arrives at the top of the ascent with a current vehicle speed approximately equal to vₛₑₜ. Because the vehicle speed was increased prior to the increase in grade, vehicle operation may be maintained in electric-only mode through the climb.

Variations of the above are, of course, possible. As an example, embodiments according to the present disclosure may be implemented in a vehicle that is not equipped for regenerative braking. Such vehicles may also see fuel economy gains due to decreased fuel expended prior to a decrease in road grade or during an increase. As another example, embodiments according to the present disclosure may be implemented in conjunction with a controller in a fully automated vehicle, rather than in conjunction with a traditionally-driven vehicle provided with an ACC algorithm.

As may be seen from the various embodiments, the present disclosure provides various advantages including increased fuel economy through changes in road grade with an ACC system active. During descents, an increased portion of kinetic energy may be recaptured by regenerative braking, and during ascents the vehicle may be maintained in electric-only mode without starting the vehicle engine.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

1. A method of controlling a hybrid vehicle, comprising:
in response to an automated speed control system being active, a target vehicle speed being selected, and an anticipated change in power demand for maintaining the target vehicle speed that is based on a detected upcoming change in road grade, automatically altering current vehicle speed away from the target vehicle speed prior to arriving at the change in road grade to maintain electric-only mode operation.

2. The method of claim 1, wherein the detected upcoming change in road grade is an upcoming increase in road grade, and wherein automatically altering current vehicle speed away from the target vehicle speed comprises increasing the vehicle speed to a first vehicle speed greater than the target vehicle speed.

3. The method of claim 2, wherein the first vehicle speed is based on the lesser of a posted speed limit, and a required speed to maintain the electric-only mode operation at or above the target vehicle speed through the upcoming increase in road grade.

4. The method of claim 1, wherein the detected upcoming change in road grade is an upcoming decrease in road grade, and wherein automatically altering current vehicle speed away from the target vehicle speed comprises decreasing the vehicle speed to a second vehicle speed less than the target vehicle speed.

5. The method of claim 4, wherein the difference between the target vehicle speed and the second vehicle speed is based on a required speed to maintain vehicle speed at or below the target vehicle speed through the upcoming decrease in road grade without application of vehicle friction brakes.

6. A hybrid electric vehicle comprising:
traction wheels;
a regenerative braking system configured to provide regenerative braking torque to the traction wheels;
wheel brakes configured to provide friction braking torque to the traction wheels; and
an automated speed control system configured to control vehicle power and braking requests for the regenerative braking system and wheel brakes to maintain a target speed and to, in response to an anticipated change in power demand for maintaining the target speed based on a detected upcoming change in road grade, automatically alter a current vehicle speed away from the target speed prior to arriving at the change in road grade to maintain electric-only mode operation through the change in road grade.

7. The vehicle of claim 6, wherein the detected upcoming change in road grade is an upcoming increase in road grade, and wherein automatically altering current vehicle speed away from the target speed comprises increasing the vehicle speed to a first vehicle speed greater than the target speed.

8. The vehicle of claim 7, wherein the first vehicle speed is based on the lesser of a posted speed limit, and a required speed to maintain the electric-only mode operation at or above the target speed through the upcoming increase in road grade.

9. The vehicle of claim 6, wherein the detected upcoming change in road grade is an upcoming decrease in road grade, and wherein automatically altering current vehicle speed away from the target speed comprises decreasing the vehicle speed to a second vehicle speed less than the target speed.

10. The vehicle of claim 9, wherein the difference between the target speed and the second vehicle speed is based on a required speed to maintain vehicle speed at or below the target speed through the upcoming decrease in road grade without application of vehicle friction brakes.

11. A method of controlling a hybrid electric vehicle, comprising:
in response to an adaptive cruise control (ACC) system being active, a first target vehicle speed being selected, and a detected upcoming increase in road grade, automatically increasing current vehicle speed above the first target vehicle speed prior to arriving at the increase in road grade to maintain electric-only mode operation throughout the increased road grade; and
in response to the ACC system being active, a second target vehicle speed being selected, and a detected upcoming decrease in road grade, automatically decreasing current vehicle speed below the second target vehicle speed prior to arriving at the decrease in road grade.

12. The method of claim 11, wherein automatically increasing current vehicle speed above the first target vehicle speed comprises increasing current vehicle speed to the lesser of a posted speed limit and a required speed to maintain the electric-only mode operation at or above the target vehicle speed through the upcoming increase in road grade.

13. The method of claim 11, wherein automatically decreasing current vehicle speed below the second target vehicle speed comprises decreasing current vehicle speed to a required speed to maintain vehicle speed at or below the target vehicle speed through the upcoming decrease in road grade without application of vehicle friction brakes.
